(19) United States
(12) Patent Application Publication
(10) Pub. No.: US 2003/0204704 A1
(43) Pub. Date: Oct. 30, 2003

(54) Extended instruction sets in a platform architecture

(76) Inventor: Christopher L. Hamlin, Los Gatos, CA (US)

Correspondence Address: LSI LOGIC CORPORATION, 1621 BARBER LANE, MS: D-106 LEGAL, MILPITAS, CA, 95035, US

(21) Appl. No.: 10/135,189

(22) Filed: Apr. 30, 2002

(51) Int. Cl. G06F 15/00; G06F 9/45

(52) U.S. Cl. 712/36; 717/136

(57) ABSTRACT

The present invention is directed to extended instruction sets, compilers and platforms architectures. A system may include a plurality of platforms and a compiler operationally linked to the plurality of platforms. The platforms include sets of embedded instruction extensions selectable for implementation by a function of the platforms, the sets of embedded instruction extensions suitable for performing operations. The compiler is suitable for generating operational codes to invoke the sets of embedded instruction extensions of the platforms.

### CROSS REFERENCE TO RELATED APPLICATIONS

The present application hereby incorporates the following United Stated patent applications by reference in their entirety:

| Attorney Docket Number | Express Mail L.N./U.S.S.N. | Filing Date |
|---|---|---|
| LSI 01-390 | 10/015,194 | Nov. 20, 2001 |
| LSI 01-488 | 10/021,414 | Oct. 30, 2001 |
| LSI 01-489 | 10/021,619 | Oct. 30, 2001 |
| LSI 01-490 | 10/021,696 | Oct. 30, 2001 |
| LSI 01-524B | 10/044,781 | Jan. 10, 2002 |
| LSI 01-695 | 09/842,335 | Apr. 25, 2001 |
| LSI 01-827 | 10/034,839 | Dec. 27, 2001 |
| LSI 01-828B | 10/061,660 | Feb. 1, 2002 |
| LSI 02-0166 | EV 087 433 360 US | Apr. 30, 2002 |

### FIELD OF THE INVENTION

The present invention generally relates to the field integrated circuits, and particularly to extended instruction sets in a platform architecture.

### BACKGROUND OF THE INVENTION

With the advancement and ever increasing pervasiveness of integrated circuits into everyday life to supply consumer desires, a greater range of functionality and optimizations of integrated circuits are needed to support these needs. Specialized integrated circuits (IC) are provided to have the functions necessary to achieve the desired results, such as through the provision of an application specific integrated circuit (ASIC). An ASIC is typically optimized for a given function set, thereby enabling the circuit to perform the functions in an optimized manner. However, there may be a wide variety end-users desiring targeted functionality, with each user desiring different functionality for different uses.

Additionally, more and more functions are being included within each integrated circuit. While providing a semiconductor device that includes a greater range of functions supported by the device, inclusion of this range further complicates the design and increases the complexity of the manufacturing process. Further, such targeted functionality may render the device suitable for a narrow range of consumers, thereby at least partially removing an “economy of scale” effect that may be realized by selling greater quantities of the device.

Thus, the application specific integrated circuit business is confronted by the contradiction that the costs of design and manufacture dictate high volumes of complex designs. Because of this, the number of companies fielding such custom designs is dwindling in the face of those rapidly escalating costs.

Therefore, it would be desirable to provide a system and method for supporting extended instructions sets in a platform architecture.

### SUMMARY OF THE INVENTION

Accordingly, the present invention is directed to extended instruction sets, compilers and platforms architectures. In a first aspect of the present invention, a system includes a plurality of platforms and a compiler operationally linked to the plurality of platforms. The platforms include sets of embedded instruction extensions selectable for implementation by a function of the platforms, the sets of embedded instruction extensions suitable for performing operations. The compiler is suitable for generating operational codes to invoke the sets of embedded instruction extensions of the platforms.

In a second aspect of the present invention, a system includes a plurality of platforms and a compiler operationally linked to the plurality of platforms. The platforms include sets of embedded instruction extensions selectable for implementation by a function of the platforms, the sets of embedded instruction extension suitable for initiating operations. When the compiler receives a request to provide functionality, the compiler dynamically determines resources needed to provide the functionality, the functionality implemented through operational codes to invoke the sets of embedded instruction extensions of the platforms.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram of an exemplary embodiment of the present invention wherein a platform is shown;

FIG. 2 is an illustration of an embodiment of the present invention wherein a sea of platforms is shown;

FIG. 3 is a block diagram of an exemplary embodiment of the present invention wherein a plurality of platforms capable of receiving feedback and producing an output is shown;

FIG. 4 is an illustration of an embodiment of the present invention wherein parallelism of platforms in response to data is shown; and

FIG. 5 is an illustration of an embodiment of the present invention wherein platforms are configured in a parallel nature in response to inability of one platform to perform a desired operation on data in a desired time allotment.

### DETAILED DESCRIPTION OF THE INVENTION

Reference will now be made in detail to the presently preferred embodiments of the invention, examples of which are illustrated in the accompanying drawings.

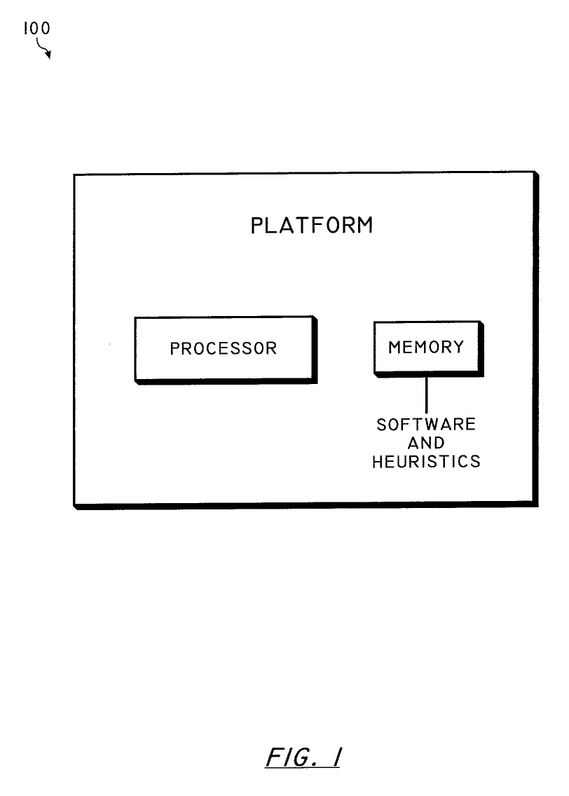

Referring generally now to FIGS. 1 through 5, exemplary embodiments of the present invention are shown. The present invention provides a mechanism whereby multiple sets of instruction extensions may be embedded in a reconfigurable core, to be selected for implementation on the fly, by means of a function in an embedded programmable logic block. Such a mechanism has the advantage of allowing specialized instructions to be mobilized during scheduled episodes which are precisely synchronized to application requirements. The instruction set extensions may be implemented in hard silicon, in ePLC block, a combination of both of them, and the like as contemplated by a person of ordinary skill in the art.

The present invention includes the use of embedded programmable logic cores in conjunction with extended instruction sets implemented via platforms, which may include reconfigurable cores and the like. Reconfigurable cores may include processor elements with which instruction set extensions directed at specialized problems may be affiliated. Typically, the instruction set extension is designed to perform specialized operations with exceptional efficiency, in order to optimize the core's use in a particular application.

These extensions may be supported by a compiler, such as a language processor or translator, which may support a high level language. The compiler is capable of generating operational codes which may invoke specialized instruction, preferably, if and only if the op codes are activated in some way on the target core.

Additionally, a coordination mechanism may be incorporated in and activated by a specialized compiler, such as a language translator, the translator including definitions which allow an ePLC function to activate the instruction set extension appropriate to the group of instructions identified by the translator.

For example, an application in which relatively long episodes involving the invocation of one set of extensions may be followed by other relatively long episodes in which another set of extensions is activated. For instance, in a streaming application with interspersed decryption and decompression episodes, the compiler and ePLC mechanism may automatically assure the presence of the correct instruction set extension at the beginning of each episode. Identification and activation may also occur on an instruction by instruction basis in contemplated embodiments of the invention.

Further, the present invention may be applied to encode a large repertoire of instruction set extensions in an efficient representation which the activated ePLC instruction may decode. In this case, the reconfigurable core and associated instruction set extensions may be thought of more like general logic mechanisms. The extensions may become the basis for a “sea of platforms” architecture, in which a considerable number of reconfigurable cores with ePLC blocks are dispersed on a high performance isochronous interconnect fabric.

In this way, the language translation role may be utilized as a sub-function of a hardware design flow, in which algorithms for efficient representation of logic functions in terms of the instruction extensions translate high level design expressions, such as RTL, into heavily optimized combinations of instruction set extensions operating in parallel and in synchrony. Thus, the platforms become vehicles for efficiently implementing general high performance logic functions in a fully programmable and adaptive environment.

Referring now to FIG. 1, an embodiment 100 of the present invention is shown wherein a platform is described. Platforms, as arranged in a system such as a “sea” of platforms, may describe an entire software conductivity architecture for ASIC, systems and the like as contemplated by a person of ordinary skill in the art. A microprocessor is included, which may be as small as supporting four-bit or eight-bit functionality, such as adder functions in adaptive silicon that may be used for a normal programmable core. Additionally, the processor may be at least 8 bits, 16 bits, or more. The processor is able to take the normal instruction data from a normal processing-type instruction data cache area, from a stream, and the like. For instance, a stream may be provided from any or all of the neighboring platforms and provide instructions, feedback, and the like.

Memory may also be included, such as nonvolatile RAM (NV RAM) which may be utilized to keep a device behavior locked in, so that when an interruption is encountered, such as loss of power, clock stoppage, and the like, the device does not lose programming. Additionally, a platform may include embedded programmable logic, memory and a reconfigurable core operable linked via an isochronous interconnect. A further discussion of a platform may be found in U.S. patent application Ser. No. EV 013 244 956 US, Attorney Docket LSI 01-524B, which is herein incorporated by reference in its entirety.

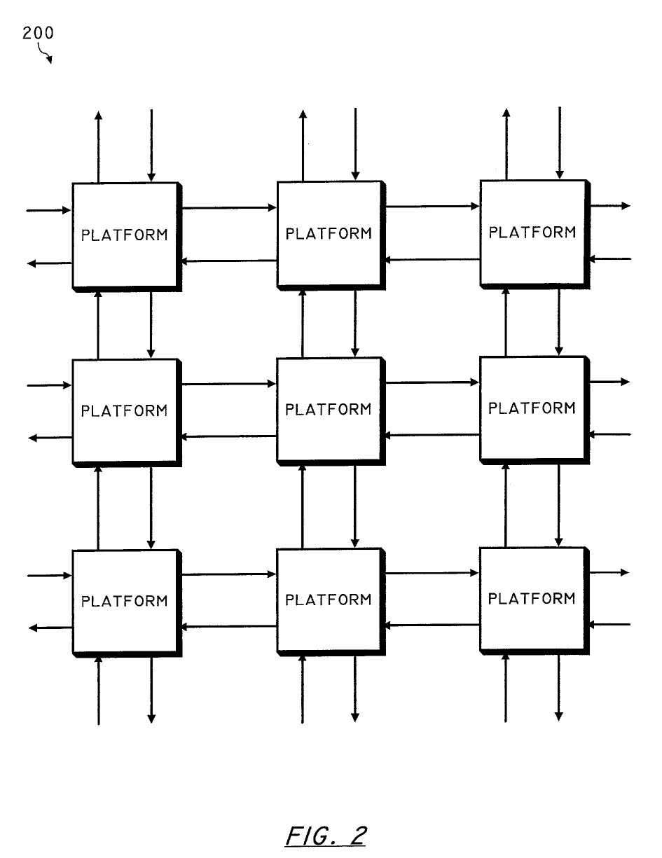

Referring now to FIG. 2, an embodiment 200 of the present invention is shown wherein a sea of platforms includes interconnections. For instance, suppose a two-dimensional structure is provided as a “sea” in which a plurality of platforms is employed, the platforms connected temporarily, programmatically and the like. Although a two-dimensional structure is described for sake of clarity in the discussion, a three-dimension structure is contemplated by the present invention without departing from the spirit and scope thereof.

Each platform may be communicatively connected to its neighbors as desired, such as the four connections shown in the figure. Additionally, the connections may be monodirectional, bidirectional and the like between platforms.

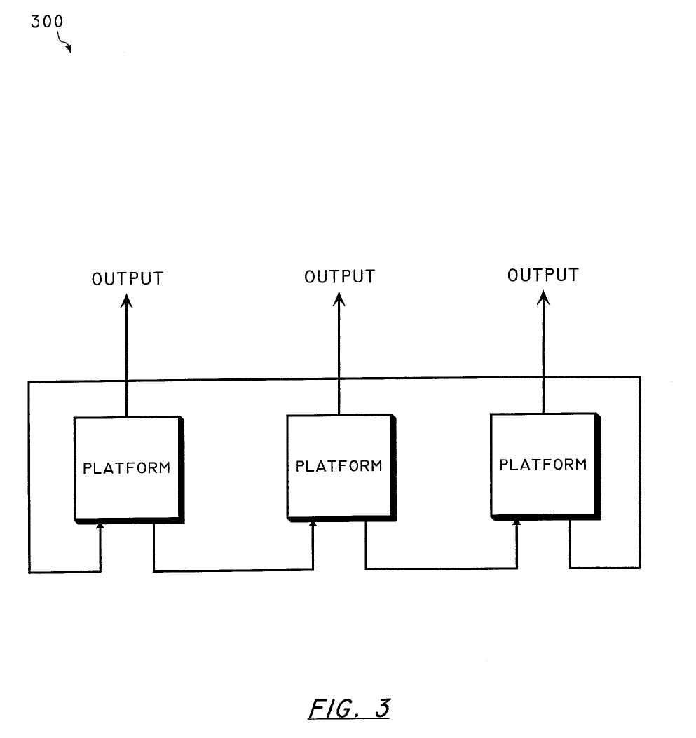

In an embodiment of the present invention, the minimum necessary and sufficient functionality is provided for each one of the platforms and the interconnect to supply dynamic route-ability and “learning” behavior. For instance, as shown in FIG. 3, “splice-ability” of the platforms is shown so that, one of the interconnects may be changed so that the platforms “feed” back on each other and yet provide the desired output. In this way, the present invention may provide dynamic function determining ability of the platforms themselves to provide the desired function.

Processor extensions and instructions may be provided in an optimized manner based on desired overall operation of the platform as well as platforms within the “sea”. For instance, an ETLP, or other kind of NV RAM or RAM-type processor extension may be supplied. These processor extensions and the possibility to extend these instructions may live completely in one platform, or may connect through creation of a path such that the instructions to operate on data coming to a first platform to a second platform, so that, in fact, the data is handled in parallel.

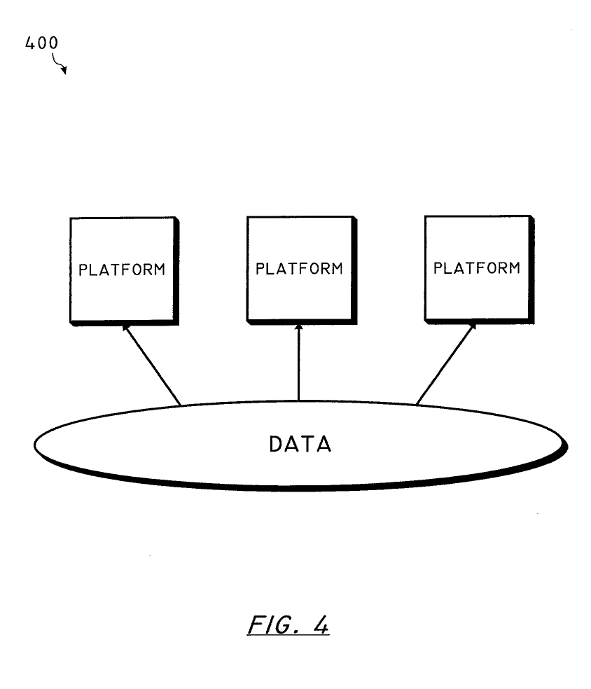

Additionally, in another aspect of the present invention, instead of burdening one of the platforms with all the possible extensions, such as 10,000, 100,000, to a million or more, compiler technology may be employed to optimize the behavior in this kind of a format. For instance, data may be received in parallel and in response to such data, the compiler may utilize a plurality of platforms as needed to get the needed parallelization, as shown in FIG. 4.

Further, instruction data feedback may be provided which is derived from the processor of a platform modifying itself. For instance, the processor may feed back into its own instruction data path, a version of which is shown in FIG. 3.

To synchronize platforms as well as inner-platform operation synchronization, a clocked synchronizing system through the entire design may be employed. In another embodiment of the invention, a variety of local clocks may be provided. For instance, each core may have its own synthesized clock, which may be included in the core itself.

A certain amount of bandwidth may be provided, and therefore it may be preferable to schedule the bandwidth to the extent desired. Isochronous architecture may also be employed by the present invention. For instance, an isochronous time pulse may be provided so that every single core clocks itself to that pulse. Scheduling packets onto a bus may utilize the bus more efficiently than trying to simply force a plurality of packets onto the bus at once, in which, the packets may collide, causing the system to retry and utilize backlog algorithms.

An assumption may be made in certain aspects of the present invention that the total aggregate incoming bandwidth, or at least a general portion thereof, and the operations expected to make on the data will, for the most part, be known in advance. In such an instance, a certain amount of the transactions or the activity that will happen may be defined and divided as desired, even in the event that only a portion of the incoming bandwidth and/or operations are known. For example, predictions may be made based on a portion of the data analyzed.

Typically, isochronous packets are provided in a fixed size. However, by utilizing the present invention, variable packet sizes may be used. For instance, Intake 3, Intake 4, Intake 7 or a variety of other compression and security standards may be utilized and handled differently on various data types.

A local data structure, such as NV RAM and the like, may be provided in the platform that defines a variety of functions of the platform. Additionally, the local data structure may have temporality. For instance, in the terms of a time base, temporality may define how many clocks should be taken to perform a function for every cycle start. Such information may be useful in a variety of instances, such as some PLL may be provided in the output from a save log loop and a frequency synthesizer, such as a clock that runs the synchronous logic.

For instance, a platform operating on data may be synchronized so that it does not operate on the data substantially faster or any slower than a neighbor is operating on the data. A time base definer may be employed that defines the time base of the synchronization, which may be in clocks, actual time and the like as contemplated by a person of ordinary skill in the art. Therefore, data packets may be defined by how often and how big the data packets are in time and in data blocks.

A second aspect is performance. In performance, raw band width, latency, jitter and the like are addressed. By employing the present invention, a determination may be made of the necessary operational parameters to effect a desired operation. For example, jitter includes whether particular blocks will be able to operate on received instructions, depending on the PLL. In some cases, a legacy platform may be included which does not have acceptable jitter for a particular data type because the clock is not accurate coming out of the PLL. The legacy platform, for instance, may only go up to 500 megahertz, and in the future a platform is needed that runs at 2 gigahertz, with 500 Pico second resolution. A determination may be made by the system that the system may not meet criteria for jitter, latency or the like.

Platforms may make such a performance determination by the data received, such as how much data at one time is being received. The notion is that the platforms are able to buffer up and/or be able to operate on the data, and are thus programmable in that sense. In the first instance of platform operation, initial platform configurations may be programmed.

In additional aspects of the present invention, the compiler may include routine intelligence, so that the compiler may receive criteria, and determine operational capacity, such as whether a certain job may be performed, and thus, whether the system is capable of performing a requested function. A data structure may be provided which is operable by a platform and/or compiler to provide this operational analysis.

Additionally, a utility may be implemented, such as through a compiler of the present invention, that provides data about power and power modes, such as when a system employing the present invention may be powered down, implementation of a lower power mode, such as decreasing a number of operating platforms, utilization of a lower clock rate to get a desired combination of bandwidth and latency, and the like as contemplated by a person of ordinary skill in the art.

“Dimensionality” is also addressed by the present invention, which may include what is the conductivity of the platforms, such as what platform is connected to what platform, the device or utility that needs such information, routes for obtaining such data by a platform, and the like. For instance, if the only parameter specified is an input path for a system, such as the system described in FIG. 2, then the system may have free reign to make the criteria in any way desired. In this way, dimensionality of the present invention may be configured based on the received parameters for performing a desired operation, and through use of the compiler and platforms, arrive at a desired configuration for achieving the result. For instance, connectivity may be achieved through multiple ports of an architecture of the present invention, the connectivity based on the same time frame.

Additionally, there are other concepts in this data structure as well of overall system conductivity, delivery, scheduling and the like, such as bandwidth management functionality, and the like, to determine output.

Referring again to FIG. 2, a plurality of platforms is disposed in a fabric. A pulse may be employed from at least one and possibly all of the ports on the fabric. From the dimensional point of view, every one of the platforms may employ bi-directional connections between neighbors. It should be apparent that a bi-directional connection is not required by the present invention, but is instead an assumption to aid the present discussion. By employing a pulse over bi-directional connections between platforms, an input cycle start coming in any one of the ports may synchronize the “sea” without necessitating that the pulse arrive through all of the ports.

Thus, an isochronous start may be provided, in which, the start defines “X” clocks per every one of the cycle start periods. Further, by specifying the internal clock and by providing similar criteria between platforms, the platforms will be “locked” or in phase regarding the external data. Therefore, whatever data is received by a port, behaviors and outputs of the platforms will be synchronized for the corresponding outputs.

Platform outputs may also be tied onto the same bus. So when the platforms feed back, say the platforms receive data from packets received by the system, the platforms may, in turn, generate a modified or adjusted packet out into the same cycle period. The platforms may optionally put the modified or adjusted packet out on a subsequent cycle.

An advantage of “owning” the interconnect by the platforms of the present invention is that there is no absolute minimum or maximum time. For instance, the cycle time may represent the data, so that, if the data happens to be an eight kilohertz word like “sonnets”, MPEG data provided, 1394 data, and the like, the cycle time may be 125 microseconds or some division of that.

However, in other cases data with different cycle times may be encountered, such as 48 kilohertz for CD, 44.1 kilohertz for CD recording, and the like. Therefore, there may be a variety of data types that the system employing the platforms of the present invention may wish to sync.

By utilizing the present invention, the exact time of the synchronization does not depend on the architecture. For instance, the present invention may change the phase-lock loop, which may be thought of as a frequency synthesizer, which is able to adjust platform performance to meet all of the different time bases, and then ultimately, how fast and slow the platforms may run.

The interconnect may be isochronous in a preferred embodiment of the present invention. The isochronous interconnect of the present invention may have a time base as a start to the cycle. For instance, a packet may be provided which indicates data and initiation of a start cycle, which causes the platforms to be able to operate as needed without a periodic time frame.

For example, suppose a data frame is being operated on, such as a frame from MPEG, so it includes all the pixels rendered on an entire page, which may be a large portion of data, and therefore, it may have a start and a very long operational period. But then, when BMP frames are encountered, such as the reference frames that are based on previous frames, the cycle start may be small and variable. Therefore, by providing start functionality and data, the platforms of the present invention may operate as needed without a time reference. Thus, the present invention may operate with all the data types, the platforms may use the isochronous period and keep the standard clock operational.

### COMPILER

A compiler may be incorporated into the present invention to coordinate and transfer data manipulation by the platforms. For instance, a compiler may schedule data to each of the platforms to get parallelism, as shown in FIG. 4. A very long instruction word (VLIW) implies that all data materializes at the same time. In other words, portions of data for a word or for the activity may actually happen in time rather than the entirety of the data as a whole at a give time. For instance, with MP-3 or MPEG, a whole frame's worth of data is typically not received in 0.008 of a second, rather only a part of the frame is received.

To take advantage of when such data is received and to configure operations to address the received data, a variety of methods may be employed by the compiler to achieve desired parallelism based on available functionality. For example, operations may be started in parallel, stacked in a queue, and the like depending on compiler options as to the speed and performance of each of platforms, to whether the platforms and interconnect may perform as desired.

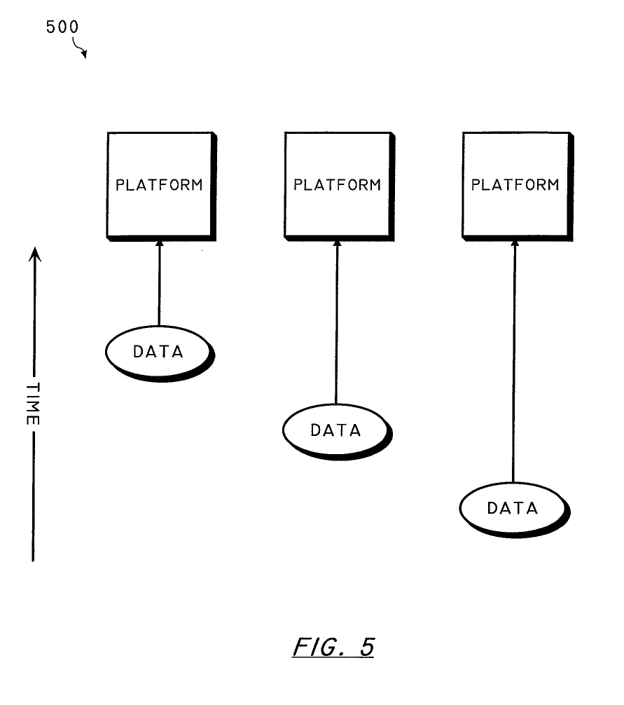

For instance, to reserve power a slow clock rate may be desired. However, if only a single platform was used, the first platform may only get halfway done with that packet by the time the next packet arrives. If the next packet is stacked, the efficiency and performance of the system may degrade if only the single platform is used, while other platforms are not used. Therefore, a second platform may be employed, and so on with each subsequent packet, as shown in FIG. 5. Therefore, the kind of parallelism desired may be achieved while saving power.

In an embodiment of the present invention, the data types are described such that the compiler may make decisions regarding the data types, the kind of temporal optimization functionality, behavioral aspects, and the like as contemplated by a person of ordinary skill in the art.

The compiler provides the right kind of instructions and the right kind of information to enable desired functionality. For instance, the compiler may define the MPEG algorithm or the coding algorithm functions so that the compiler may deduce how parallel the operation needs to be, i.e. how many platforms are needed, how extensible the instructions need to be, and the like; and then how to route the data to achieve the parallelization.

Compiler technology, as embodied in the present invention, includes a complete “give and take” of the system and dynamic configuration that extends beyond previous attempts to provide such functionality. For example, typically, multiple processors were provided and instruction sets formulated specifically for those processors. Therefore, previous systems were unable to guarantee improved performance, because the system was unable to guarantee when operations were going to be done, rather, it was just a way of utilizing resources in a predefined and rigid manner. However, the present invention may dynamically determine resource needs and employ platforms accordingly, based on functionality, bandwidth, and the like.

Therefore, through use of the present invention, by providing a time relationship of data, platforms may be grouped, interconnected, and configured on the fly to meet the needs of the data received at that time.

For instance, the present invention may be utilized in transactions. Platforms may be configured to handle a transaction, such as each platform may receive a transaction, or grouped to perform a transaction as needed, and the interconnect configured to route the data as needed, such as to a disk drive or the like. Packets may be received and data modified from its packet, the appropriate device found, and the modified packet sent on its way. Additionally, the present invention may provide changeable, remappable system to dynamically employ the platforms.

Further, the present invention may be employed in an improved system for designing an integrated circuit to enable greater flexibility of the design, such as the System and Method for Designing an Integrated Circuit described in the patent application filed Oct. 30, 2001, EV 013 245 404 US, Attorney Docket Number LSI 01-489, which is herein incorporated by reference in its entirety.

For instance, platforms may be connected as desired and an interconnect for each of the platforms defined with a variety of parameters, such as performance, the criteria discussed with relation to the conductivity data structure, and the like as contemplated by a person of ordinary skill in the art. This may enable the compiler to input the actual structure of the system more easily and to be able to determine how to utilize the functionality of the system.

There are two aspects to this, for instance, a codec may be absolutely defined as a functional block. For instance, from a high-level architectural point of view, a codec, an Ethernet controller, and the like may be defined in terms of behavior, instead of in terms of shift registers and RAM. Thus, functional behaviors may be defined at a high level, even microprocessors may be defined.

For example, a 32-bit processor may be specified by a functional block, even though at a “lower” level of the design, through use of platforms and the like, 4-bit processors are utilized in conjunction to provide the functionality. Further, a user of such a device may not even be aware of what is actually providing the functionality, but rather is aware that the specified functionality is being provided. Therefore, a user is able to configure these high-level constructs and define the connectivity between them. Some of the functional blocks will be defined and thus, known how to synthesize ahead of time into what kind of behavior happens at the “lower” level. However, some of the other functional blocks may have to be modified to achieve the desired performance.

Additionally, a compiler of the present invention may utilize a series of exemplars, template examples, and the like, so that when utilized by a consumer, the compiler breaks it down and renders it to map to a “sea of platforms”. For example, functionality may be defined in the cores, and then the minimal necessary but sufficient pieces are chosen to get the kind of performance desired. It may be preferable to utilize the minimum pieces to get the basic functionality desired, for power savings, resource efficiency, and the like. The functional blocks may be employed in an ASIC flow, programmable logic devices, and the like, so that a flexible device may be provided.

Moreover, this enables flexibility of the system for future changes. For example, by making these constructs “soft”, a codec developed at a later time may be downloaded and implemented by the present invention. If NV RAM is provided, for example, the behavior may be changed on the very next cycle, such as isochronous cycle start, and the like. Modes may be changed and staged up, such as through an instruction cache brief batching some instructions.

For branch prediction, options are obtained for a decisional point, and thus, behavior predicted. Through use in the present invention, mode changes of the platforms, interconnects, and system as a whole may be performed in a cycle period. For instance, a cycle start packet may take a few hundred nanoseconds in an aspect of the invention, depending on the speed of the bus. Thus, devices may switch modes and perform other configuration changes in a few phases, and predict and fetch such changes for further efficiency.

Therefore, whether the system of the present invention is programmed on the fly, from a stream data input that is received from an external source and staged as a new functionality, or whether it is set-up ahead of time within three, four, or five modes and are then staged, the programming may be staged out of a local RAM, derived dynamically, and the like.

Additionally, other functions may be implemented through a single platform, because of the temporality of the function. For instance, MP-3 data may be manipulated by one platform because typically two to six bytes are obtained every eight-thousandths of a second. Thus, a single platform may operate on that data and get it done by the time of 125 microseconds.

From utilization of high-level blocks, a variety of platforms may be grouped to perform the function. For instance, a block representing a NIPS microprocessor might require a hundred of the platforms to provide the functionality, a codec may involve a few hundred platforms, a disk interface might be a hundred to a few thousand, and the like.

By employing an extraction process of the present invention, interconnect functionality and programmatic extensions may be utilized to materialize desired functionality into a sea of platforms, the sea of platforms configured and divided to provide the functionality needed and when the functionality is needed, i.e. temporal considerations.

A variety of implementations may be pre-constructed for efficiency. For example, processors such as ARM, RXs or NIPS, codecs, a variety of other interconnects to disk, such as SCSI, Serial ATA, or Parallel IDE ATA, and cores, such as Ethernet controllers, and the like may be pre-designed and optimized so the software may extract it quickly and efficiently, without having to reconstruct the element.

Thus, in an aspect of the present invention, various functional elements are given “behaviors” to indicate how the element functions with respect to its neighbors, as well as describing the desired functions. Some languages that may be employed in such a description include “MASTAD”, 4-GL, and the like.

The present invention provides a high level definition of interaction between devices, through an abstraction language that may include how the processes are connected and what the process “is” so that the functionality and interaction may be synthesized and extracted between the sea of platforms, conductivity and performance.

In this way, the present invention may also provide formal verification including temporal considerations, grouping and parallelism. For instance, the present invention may describe the behavior of multiple platforms, and group the platforms depending on the behavior and the functionality desired. Additionally, the platforms may be grouped, into temporal groupings.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

Although the invention has been described with a certain degree of particularity, it should be recognized that elements thereof may be altered by persons skilled in the art without departing from the spirit and scope of the invention. One of the embodiments of the invention can be implemented as sets of instructions resident in the memory of one or more information handling systems, which may include memory for storing a program of instructions and a processor for performing the program of instruction, wherein the program of instructions configures the processor and information handling system. Until required by the information handling system, the set of instructions may be stored in another readable memory device, for example in a hard disk drive or in a removable medium such as an optical disc for utilization in a CD-ROM drive and/or digital video disc (DVD) drive, a compact disc such as a compact disc-rewriteable (CD-RW), compact disc-recordable and erasable; a floppy disk for utilization in a floppy disk drive; a floppy/optical disc for utilization in a floppy/optical drive; a memory card such as a memory stick, personal computer memory card for utilization in a personal computer card slot, and the like. Further, the set of instructions can be stored in the memory of an information handling system and transmitted over a local area network or a wide area network, such as the Internet, when desired by the user.

Additionally, the instructions may be transmitted over a network in the form of an applet that is interpreted or compiled after transmission to the computer system rather than prior to transmission. One skilled in the art would appreciate that the physical storage of the sets of instructions or applets physically changes the medium upon which it is stored electrically, magnetically, chemically, physically, optically or holographically so that the medium carries computer readable information.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A system, comprising:
a plurality of platforms, the platforms including sets of embedded instruction extensions selectable for implementation by a function of the platforms, the sets of embedded instruction extensions suitable for performing operations;
a compiler operationally linked to the plurality of platforms, the compiler suitable for generating operational codes to invoke the sets of embedded instruction extensions of the platforms.

2. The system as described in claim 1, wherein the compiler includes a coordination mechanism to temporally effect an instruction set extension appropriate to operational codes.

3. The system as described in claim 1, wherein the compiler is configured as a language translator.

4. The system as described in claim 1, wherein the compiler receives a request for a desired function, the compiler generates a parallel configuration of the plurality of platforms to perform the function.

5. The system as described in claim 1, wherein the platforms are communicatively coupled via an isochronous fabric.

6. The system as described in claim 1, wherein at least one of a local clock is utilized for sub-grouping of the plurality of platforms; each platform includes a clock; and platforms clock to an isochronous time pulse.

7. The system as described in claim 1, wherein the compiler determines, from at least a portion of received data, resources needed to perform an operation.

8. The system as described in claim 1, wherein the determined resources include information needed to configure the platforms in at least one of a temporal and parallel manner.

9. The system as described in claim 1, wherein the compiler configures the platforms based on power and power modes.

10. The system as described in claim 1, wherein the compiler implements soft functional blocks, the functional blocks corresponding to elements of an integrated circuit.

11. The system as described in claim 10, wherein the elements include at least one of a processor, codec and translator.

12. The system as described in claim 1, wherein the platform includes platforms including embedded programmable logic, memory and a reconfigurable core.

13. A system, comprising:
a plurality of platforms, the platforms including sets of embedded instruction extensions selectable for implementation by a function of the platforms, the sets of embedded instruction extension suitable for initiating operations;
a compiler operationally linked to the plurality of platforms, wherein the compiler receives a request to provide functionality, the compiler dynamically determines resources needed to provide the functionality, the functionality implemented through operational codes to invoke the sets of embedded instruction extensions of the platforms.

14. The system as described in claim 13, wherein the resources include at least one of interconnect bandwidth and platform temporal functionality.

15. The system as described in claim 13, wherein if the compiler determines inadequate resources to provide the functionality, the compiler returns an indication to a requester originating the request.

16. The system as described in claim 13, wherein the compiler includes a coordination mechanism to temporally effect an instruction set extension appropriate to operational codes.

17. The system as described in claim 13, wherein the compiler is configured as a language translator.

18. The system as described in claim 13, wherein the compiler receives a request for a desired function, the compiler generates a parallel configuration of the plurality of platforms to perform the function.

19. The system as described in claim 13, wherein the platforms are communicatively coupled via an isochronous fabric.

20. The system as described in claim 13, wherein at least one of a local clock is utilized for sub-grouping of the plurality of platforms; each platform includes a clock; and platforms clock to an isochronous time pulse.

21. The system as described in claim 13, wherein the compiler determines, from at least a portion of received data, resources needed to perform an operation.

22. The system as described in claim 13, wherein the determined resources include information needed to configure the platforms in at least one of a temporal and parallel manner.

23. The system as described in claim 13, wherein the compiler configures the platforms based on power and power modes.

24. The system as described in claim 13, wherein the compiler implements soft functional blocks, the functional blocks corresponding to elements of an integrated circuit.

25. The system as described in claim 24, wherein the elements include at least one of a processor, codec and translator.

26. The system as described in claim 13, wherein the platform includes platforms including embedded programmable logic, memory and a reconfigurable core.

27. A system, comprising:
a plurality of platforms, the platforms including sets of embedded instruction extensions selectable for implementation by a function of the platforms, the sets of embedded instruction extension suitable for performing operations;
a means for compiling operationally linked to the plurality of platforms, wherein the compiling means receives a request to provide functionality, the compiling means dynamically determines resources needed to provide the functionality, the functionality implemented through operational codes to invoke the sets of embedded instruction extensions of the platforms.
